(19) United States
(12) Patent Application Publication
(10) Pub. No.: US 2008/0257123 A1
(43) Pub. Date: Oct. 23, 2008

(54) BACON SLICING APPARATUS

(76) Inventor: Rodney Groce WILLIAMS, Doniphan, NE (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/845,382

(22) Filed: Aug. 27, 2007

Related U.S. Application Data
(60) Provisional application No. 60/913,453, filed on Apr. 23, 2007.

(51) Int. Cl. B26D 7/06

(52) U.S. Cl. 83/409

(57) ABSTRACT

A system and method for using a self standing slicing apparatus to slice sheets of bacon in half. The slicing apparatus can have two conveyor belts for receiving sheets of bacon to be cut in half, a motor for driving the conveyor belts and moving the sheets of bacon through a cutting mechanism thereby cutting the sheets of bacon into two pieces. A safety enclosure can enclose the cutting mechanism. Markings can be used to indicate where the sheets of bacon should be placed on the conveyor belts to ensure that the product is cut into two approximately even pieces. A control panel can be used to start and stop the conveyor belts as well as adjusting the speed of the motor for driving the conveyor belts.

### CROSS REFERENCE TO RELATED APPLICATION

This application claims priority to U.S. Provisional Application No. 60/913,453, filed Apr. 23, 2007, herein incorporated by reference in its entirety.

### BACKGROUND INFORMATION

Bacon is a popular food item that can be used in sandwiches, such as, cheeseburgers, grilled cheeses, egg and cheese, BLTs (bacon, lettuce and tomato), and club sandwiches. When making such sandwiches, the bacon may be broken in half in order to fit on the sandwich. When making a large quantity of sandwiches, breaking the bacon in half can become time consuming. For example, in a fast-food restaurant where time is important and the demand for bacon may be high, breaking bacon in half may waste valuable time. Thus, there is a need for bacon which is approximately half of its conventional size.

### BRIEF DESCRIPTION OF THE DRAWINGS

Purposes and advantages of the exemplary embodiments will be apparent to those of ordinary skill in the art from the following detailed description in conjunction with the appended drawings in which like reference characters are used to indicate like elements, and in which:

FIG. 1 is a perspective view of a slicing apparatus without a safety enclosure in accordance with an exemplary embodiment of the present disclosure;

FIG. 2 is a perspective view of a slicing apparatus with a safety enclosure in accordance with an exemplary embodiment of the present disclosure;

FIG. 3 is a perspective view of a safety enclosure in accordance with an exemplary embodiment of the present disclosure;

FIG. 4 is a side view of a slicing apparatus without a safety guard in accordance with an exemplary embodiment of the present disclosure;

FIG. 5 is a top view of a slicing apparatus in accordance with an exemplary embodiment of the present disclosure;

FIG. 6 is an end view of a slicing apparatus in accordance with an exemplary embodiment of the present disclosure;

FIG. 7 is a block diagram of a control panel for a control assembly in accordance with an exemplary embodiment of the present disclosure;

FIG. 8 a block diagram of a mounting plate of the controller assembly in accordance with an exemplary embodiment of the present disclosure;

FIG. 9 is a high level circuitry schematic for a control assembly in accordance with an exemplary embodiment of the present disclosure; and

FIG. 10 is a flow diagram of a method for using a slicing apparatus in accordance with an exemplary embodiment of the present disclosure.

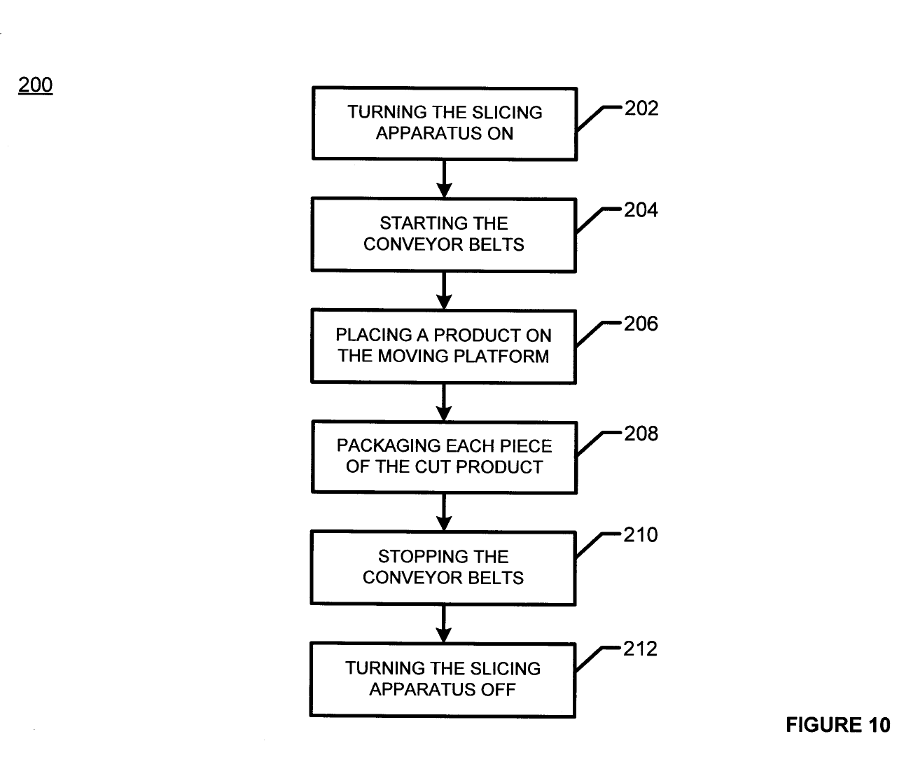

These and other embodiments and advantages will become apparent from the following detailed description, taken in conjunction with the accompanying drawings, illustrating by way of example the principles of the various exemplary embodiments.

### DETAILED DESCRIPTION OF EXEMPLARY EMBODIMENTS

A slicing apparatus in accordance with exemplary embodiments of the present disclosure can include two conveyor belts for receiving a product to be cut in half, a motor for driving the conveyor belts and moving the product through a cutting mechanism thereby cutting the product into two pieces. A safety enclosure can enclose the cutting mechanism. Markings can be used to indicate where the product should be placed on the conveyor belts to assist in ensuring that the product is cut into two horizontally even pieces. A control panel can be used to start and stop the conveyor belts as well as adjusting the speed of the motor for driving the conveyor belts.

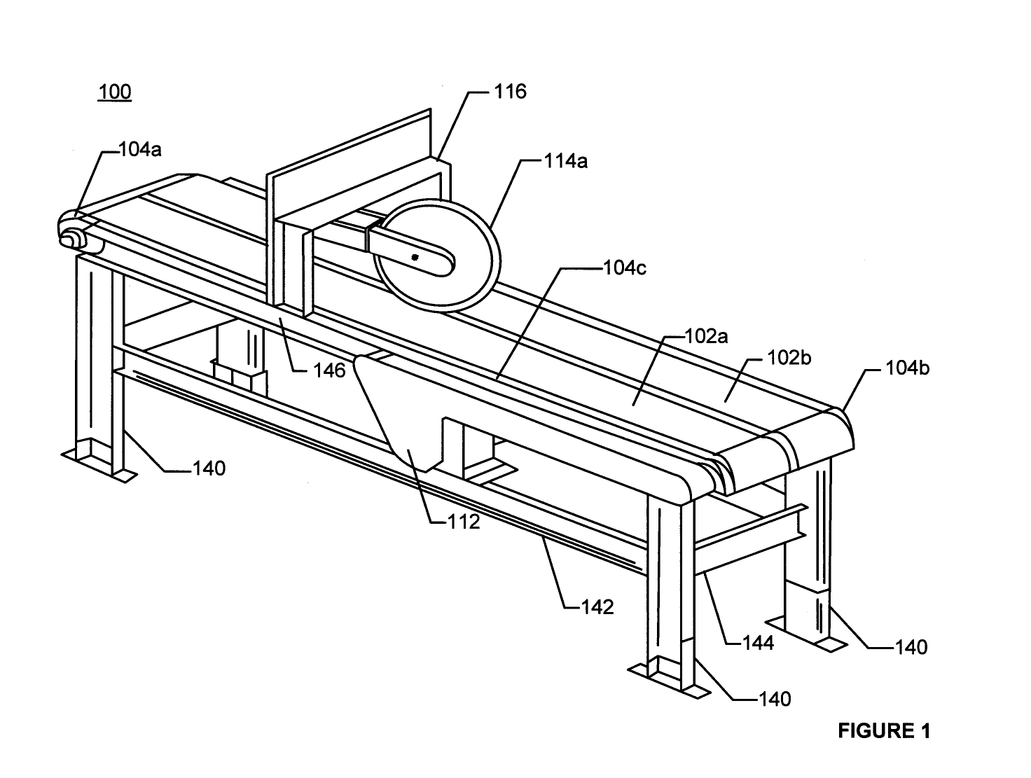

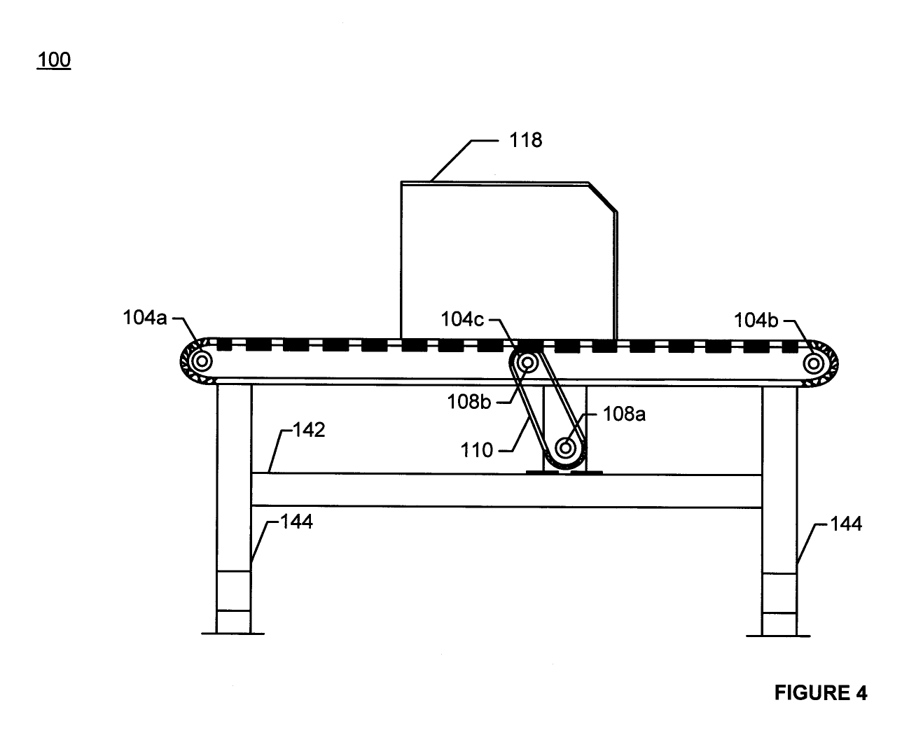

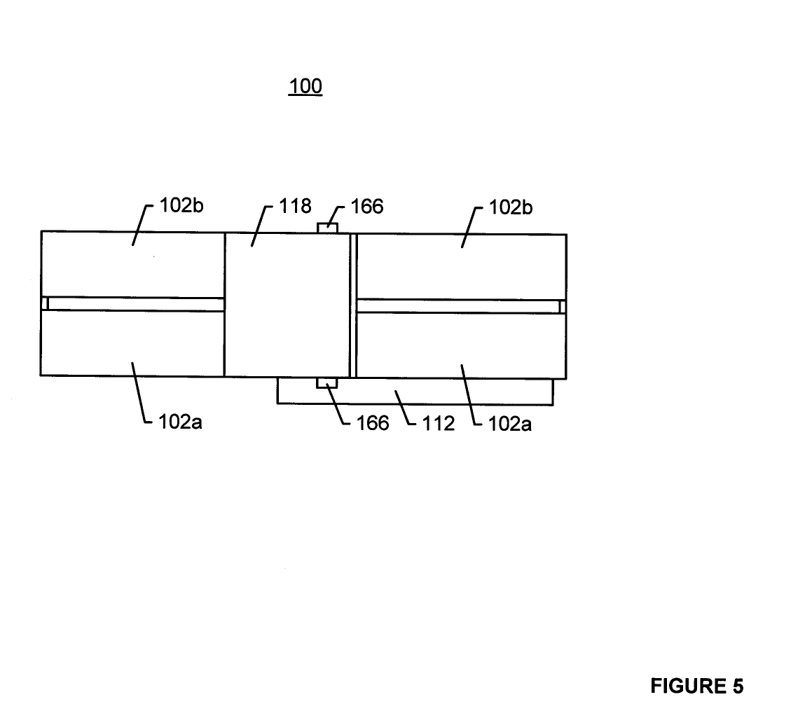

Referring to FIGS. 1-6, a slicing apparatus for cutting or slicing a product into two pieces in accordance with an exemplary embodiment of the present disclosure is illustrated. The slicing apparatus 100 can include a moving platform assembly, a motor assembly, a cutting assembly, a controller assembly, and a frame assembly. The description below describes the assemblies of the slicing apparatus 100. It is noted that these assemblies are exemplary. The assemblies, or components of an assembly, may be combined, integrated, divided, and/or separated into one or more assemblies or sub-assemblies.

The moving platform assembly can include one or more conveyor belts 102. As shown, the moving platform assembly can include two conveyor belts 102a, 102b. The conveyor belts 102a, 102b can be Intralox Series 900 Raised Rib Belts, which are manufactured by Intralox headquartered in New Orleans, La. In an exemplary embodiment, each conveyor belt 102 can have the following dimensions: seventy-six and a half inches long by sixteen and eleven sixteenth inches wide by thirty-six inches top of belt (76½″ long×16 11/16″ wide×36″ top of belt). The conveyor belts 102a, 102b can be side by side and can be positioned to receive a product at a first end, move the product through the cutting assembly and output the resulting products at a second end.

For example, the conveyor belts 102a, 102b can receive a product, such as, but not limited to, a single slice of bacon or a shingle or sheet of bacon at an infeed end of the conveyor belts 102a, 102b, move the bacon through the cutting assembly and provide the two halves of bacon at an outfeed end of the conveyor belts 102a, 102b. A shingle of bacon can comprise fifty (50) slices of bacon which are stacked on top of one another, e.g., as seen in grocery stores. A sheet of bacon can be a plurality of sliced bacon similar to the bacon one may purchase at the grocery store. Typically, the bacon run through the slicing apparatus 100 is cooked, however the bacon can be uncooked or partially cooked.

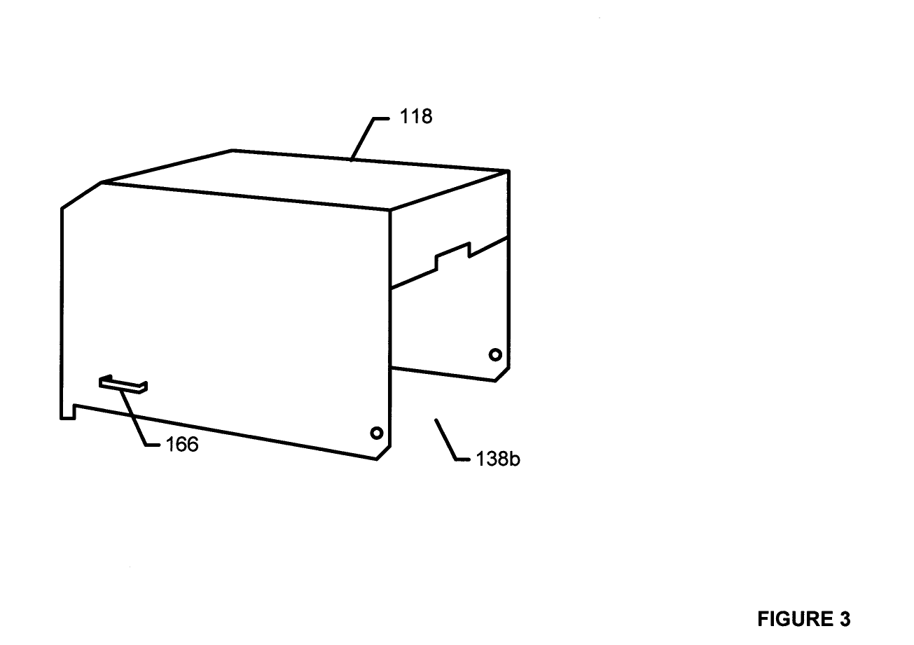

The moving platform assembly can include two or more rollers 104 for assisting in the movement of the conveyor belts 102. As shown in FIG. 3, the slicing apparatus 100 can include three bottom rollers 104a, 104b, 104c. The rollers 104a, 104b, 104c can be, for example, delrin and/or knurled rollers. In an exemplary embodiment, the rollers 104a, 104b, 104c can be one inch (1″) in diameter. First and second bottom rollers 104a, 104b can be positioned at about each end of the conveyor belts 102. A third bottom roller 104c can be interposed between the first and second bottom rollers 104a, 104b. The third bottom roller 104c can be a driven roller (or driven sprocket), e.g., a driven delrin bottom roller. The third bottom roller 104c can be driven by the motor assembly.

The motor assembly can include a motor 106 to drive the moving platform assembly. The motor 106 can be a direct current (DC) motor and/or can be a variable speed DC motor, such as, but not limited to, a ninety volt direct current (90 VDC) Washdown duty generator. The motor 106 can include a motor guard (not shown) substantially covering the motor 106. The motor guard can assist in keeping foreign objects, such as but not limited to dirt, dust, and fingers, away from the motor 106. The motor 106 can drive the third bottom roller 104c which in turn drive the conveyor belts 102a, 102b. The motor 106 can be coupled to the conveyor belts 102a, 102b as known in the art.

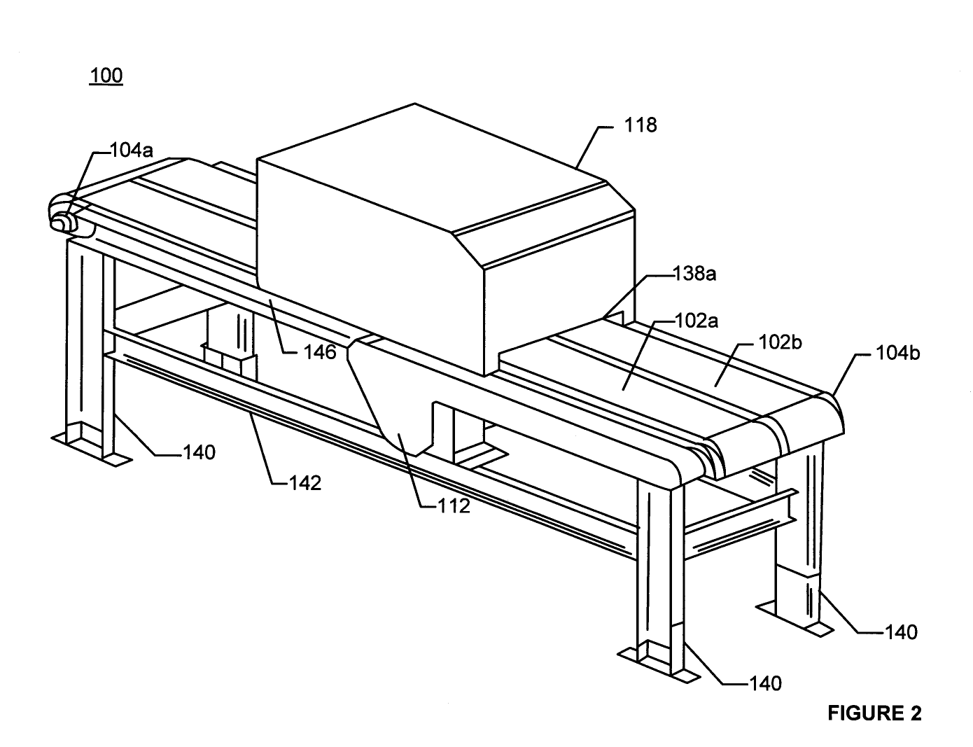

For example, the motor 106 can include a pulley or a drive sprocket 108a, the third driven bottom roller 104c can include a pulley or a driven sprocket 108b, and a belt 110, e.g., a pulley belt, which can connect the pulleys 108a, 108b as shown in FIG. 3. Thus, the motor 106 drives the attached pulley 108a which in turn drives the belt 110, which in turn drives the pulley 108b attached to the third driven bottom roller 104c, which in turn drives the conveyor belts 102a, 102b. As shown in FIGS. 1 and 2, a safety guard 112 can cover the pulleys 108 and the belt 110. The safety guard 112 can assist in keeping foreign objects, such as but not limited to dirt, dust, and fingers, away from the pulleys 108 and belt 110.

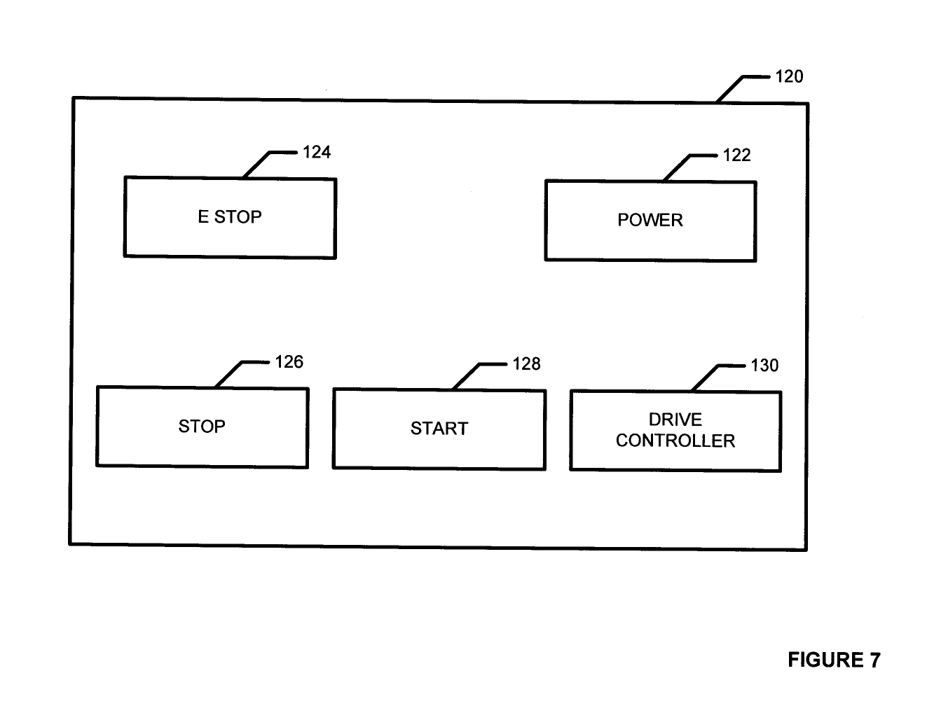

Referring to FIG. 7, a block diagram of a control panel of the controller assembly in accordance with an exemplary embodiment of the present disclosure is illustrated. As shown, the control panel 120 for the controller assembly can include one or more devices to control the operation of the slicing apparatus 100. As shown, the control panel 120 can include a power controller 122, an emergency stop controller 124, a stop controller 126, a start controller 128, and a drive controller 130. The control panel 120 can reside in an electrical control cabinet.

The power controller 122 can control a power supply 134 of the slicing assembly 100. The power controller 122 can be an on/off switch or button, such as a twenty (20) amp on/off switch. When the power controller or button 122 is pushed, the slicing apparatus 100 can be turned on. When the power controller or button is 122 is pushed again, the slicing apparatus 100 can be turned off.

The emergency stop controller 124 can be an on/off switch or button. The emergency stop controller 124 normally can be in the closed position. When the emergency stop controller or button 124 is pressed, the power to the motor 106 can be shut off which in turn can cause the conveyor belts 102a, 102b to stop moving. The emergency stop controller 124 is intended to stop the conveyor belts 102a, 102b in case of an emergency.

The stop controller 126 can cause the motor 106 to stop which in turn can cause the conveyor belts 102a, 102b to stop moving. The start controller 128 can start the motor 106 which in turn can cause the conveyor belts 102a, 102b to move. The stop controller 126 and start controller 128 can be switches or push buttons. The drive controller or speed controller 130 can control the speed of the variable speed motor 120. The drive controller 130 can be a potentiometer, for example, a 2 k potentiometer. The drive controller 130 controls the speed of the variable speed motor 120 via the DC driver 152. The variable speed motor 106 controls the speed of the conveyor belts 102a, 102b. Specifically, the drive controller 130 controls the speed of the motor 106, which in turn controls the speed of the pulley 108a coupled to the motor 106, which is coupled to and controls the speed of the third driven bottom roller 104c, via the pulley belt 110, which controls the speed of the conveyor belts 102a, 102b.

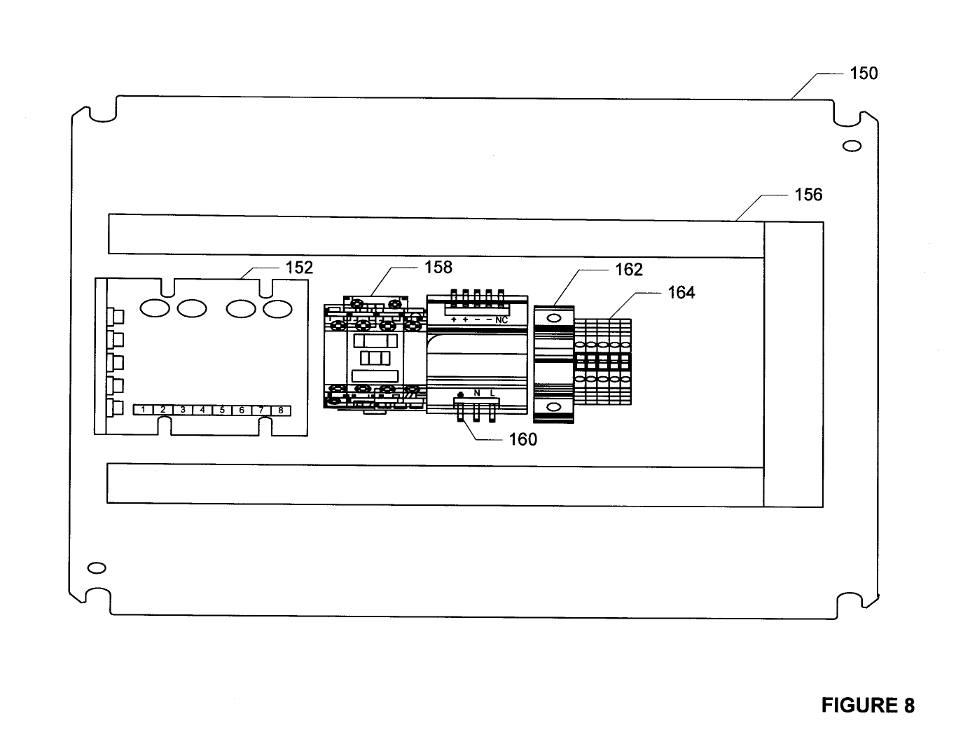

Referring to FIG. 8, a block diagram of a mounting plate of the controller assembly in accordance with an exemplary embodiment of the present disclosure is illustrated. As shown, the control panel 120 can include a mounting plate 150. The mounting plate 150 can include a DC driver 152 (such as a Dart Controls DC driver), a din rail 154, and one or more wire trays 156. The din rail 154 can include a contactor 158, a power connection 160, a fuse holder 162 for holding fuse 132, and a terminal block 164. The terminal block 164 can include an end anchor and a ground terminal.

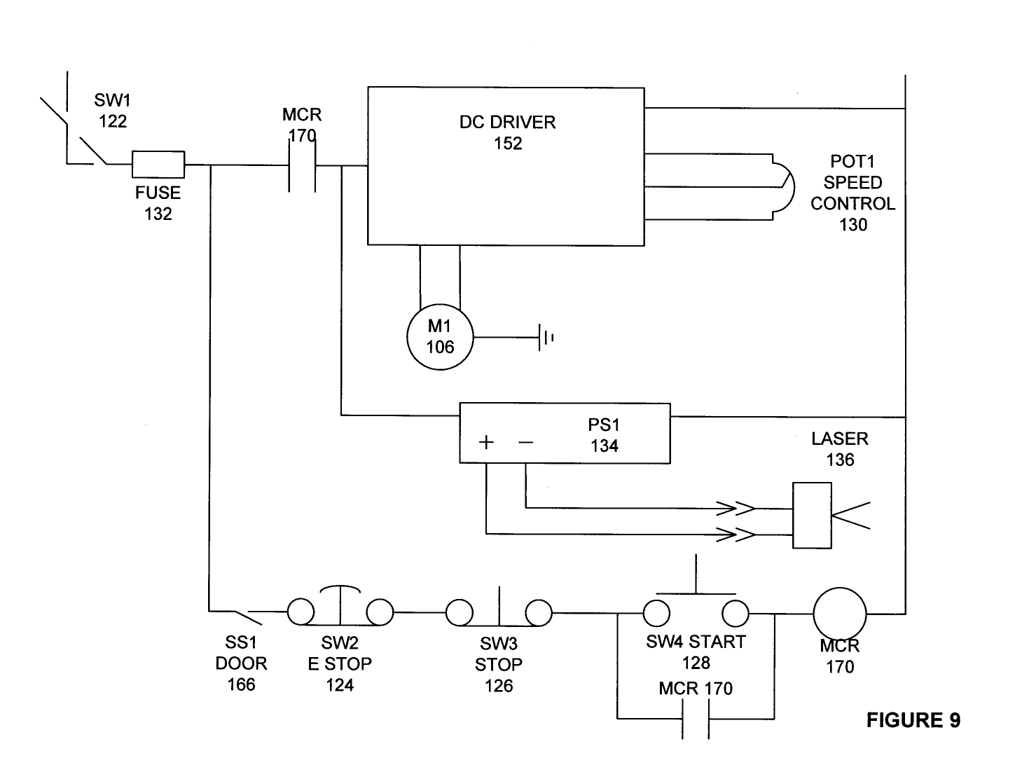

Referring to FIG. 9, a high level circuitry schematic for the control panel in accordance with an exemplary embodiment of the present disclosure is illustrated. Though not shown in FIG. 1, additional components, such as, capacitors, resistors, wires, etc., may exist in the actual circuitry schematic for the control panel. The slicing apparatus 100 can be powered using a standard plug plugged into a wall outlet, e.g., a one-hundred-twenty volt alternating current, sixty hertz, fifteen ampere (120 VAC/60 Hz/15 AMP) service. The power controller 122 controls the power to the slicing apparatus 100. When the slicing apparatus 100 is turned on, e.g., the power controller 122 is pressed, power can be provided to the DC motor 106, the switches in the control panel 120, lasers 136, and an internal power supply 134. The internal power supply 134 can be used to provide power to one or more lasers 136 which are described in further detail below. As shown, the circuit also includes several controllers or switches, e.g., the emergency stop controller or switch 124 which can normally be in the closed position, the stop controller or switch 126 which is in the normally closed position, and the start controller or switch 128. Also shown, is a door switch 168, e.g., a trojan door safety switch, which can be used to ensure that an access door (not shown) to the electrical control cabinet is closed. The door switch 168 can be a safety measure to assist in ensuring that no one can improperly access the electronic components while the slicing apparatus is running. In addition, one or more master control relays (MCRs) 170 can verify that the safety circuits are in the proper position, e.g., the door switch 168 is closed, the emergency stop controller or switch 124 is closed, the stop controller or switch 126 is closed, and the start controller or switch 128 is closed, in order to provide power to the motor 106.

Returning to FIGS. 1-6, the slicing assembly 100 can include the cutting assembly for cutting or slicing a product on the moving platform into two pieces. The cutting assembly can include a cutting mechanism 114 and a cutting mechanism support frame 116. The cutting mechanism 114 can be supported by the cutting mechanism support frame 116 which can attach to the frame of the slicing apparatus 100. The cutting mechanism 114 can be, for example, a knife, a saw, a blade, or any other object that can cut through a product. As shown in FIG. 1, the cutting mechanism 114 can be a counterbalanced top cutter wheel 114a. The counterbalanced top cutter wheel 114a can be a round cutting blade, e.g., about a foot in diameter with a relatively dull blade.

The cutting mechanism 114 can be positioned at an opening between the two conveyor belts 102a, 102b such that when the conveyor belts 102a, 102b moves the product from one end to the other end of the conveyor belts 102a, 102b, the cutting mechanism 114 can cut or slice through the product. The counterbalanced top cutter wheel 114a can be adjusted in the vertical direction to cut through the product, but not through a carrier carrying the product. For example, the product can be placed on a carrier, such as, but not limited to, paper, a foam tray, or a cutting board, with the counterbalanced top cutter wheel 114a cutting through the product and against, but not through, the carrier. In another embodiment, a single conveyor belt (not shown) can be used in conjunction with the counterbalanced top cutter wheel 114a with the conveyor belt serving as the carrier. A safety enclosure 118 can cover part of the cutting assembly.

The safety enclosure 118 can assist in preventing a worker from accidentally being injured by the cutting mechanism 114. The safety enclosure 118 can be a lexan safety enclosure. The safety enclosure 118 can be made of wire cloth brand welded lock and crimp style stainless steel wire mesh. The safety enclosure 118 can form openings 138a, 138b (e.g. the area between the top surface of the conveyor belts 102a, 102b and the bottom of the safety enclosure 118) at the sides or ends in which the product enters and exits under the safety enclosure 118, e.g., the sides facing the conveyor belts 102. As shown in FIG. 2, a first opening 138a can be located on the input side of the safety enclosure 118, e.g., the side where the product to be sliced enters the safety enclosure 118. The first opening 138a can be approximately one and a half inches (1.5″). As shown in FIG. 3, a second opening 138b can be located on the output side of the safety enclosure 118, e.g., the side where the sliced product exits the safety enclosure 118. The safety enclosure 118 can include securing mechanisms (not shown) to secure the safety enclosure 118 in a set position, e.g., to the frame of the slicing apparatus 100. The securing mechanisms can be gas springs enclosed within the safety enclosure 118. The safety enclosure can include one or more handles 166 which can assist a user in positioning and removing the safety enclosure 118.

The conveyor belts 102a, 102b can include one or more markings (not shown) to indicate where the product should be placed. The markings can serve as a left and right boundary. For example, each of the conveyor belts 102a, 102b can include lines indicating a left boundary and a right boundary. In one embodiment, the slicing apparatus 100 can include one or more lasers 136 to provide the markings. The lasers 136 can emit a light, visible to the human eye, that is projected onto each of the conveyor belts 102a, 102b, thereby marking the left boundary and the right boundary. The one or more lasers 136 can be turned on with the power controller 122. The lasers 136 can be mounted to the safety enclosure 118.

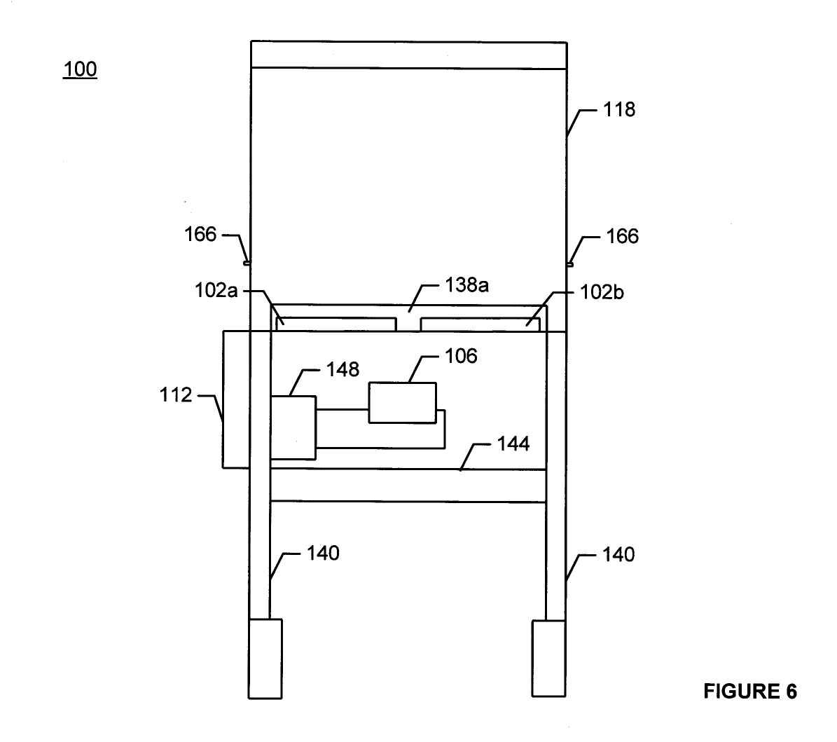

The slicing apparatus 100 can include a frame assembly. The frame assembly can allow the slicing apparatus 100 to be self standing. The frame assembly can include four vertical legs 140, two horizontal cross members 142, two width cross members 144, and two horizontal support members 146 (collectively the “frame”) as shown in FIGS. 1,2, and 4-6. The other assemblies can be coupled to the frame via one or more support members. For example, as shown in FIG. 6, a motor support member 148 can support the motor 106 and be coupled to at least one of the horizontal cross members 142. The moving assembly can be coupled to the horizontal support members 146. The cutting mechanism support member 116 can be coupled to the horizontal support members 146. The safety enclosure 118 can be coupled to the cutting mechanism support member 116 and/or to the horizontal support members 146. The frame can be made of stainless steel or other suitable material. Preferable the frame (and the support members 116, 146, 148) is made of a material that is sanitary for use with food products.

Referring to FIG. 9, a method for using the slicing apparatus in accordance with an exemplary embodiment of the present disclosure is illustrated. This exemplary method is provided by way of example, as there are a variety of ways to carry out the methods according to the present disclosure. The method is described below as carried out by the slicing apparatus shown in FIGS. 1-5 by way of example, and various elements of the slicing apparatus 100 are referenced in explaining the exemplary method of FIG. 9. Each block shown in FIG. 9 represents one or more processes or methods carried out in the exemplary method. The method 200 can start in block 202 with the slicing apparatus 100 being turned on. For example, the user can press the power controller or button 122. In response to the power controller or button 122 being pushed, power can be supplied to the motor 106 and to the lasers 136. After the slicing apparatus 100 is turned on, the method 200 can proceed to block 204.

In block 204, the conveyor belts 102 can be started and if needed the speed of the conveyor belts 102 can be adjusted. For example, the user can push the start controller or button 128 which can cause the motor 106 to start thereby causing the conveyor belts 102 to move. If needed, the drive controller 130 can be adjusted to vary the speed of the motor 106 which in turn varies the speed of the conveyor belts 102a, 102b. After starting the conveyor belts 102a, 102b, and, if needed, adjusting the speed of the conveyor belts 102a, 102b, the method 200 proceeds to block 206.

In block 206, a product can be placed on the moving platform at a first end. For example, the user can place a slice of bacon or a sheet of bacon onto the conveyor belts 102a, 102b. The product can be placed on a carrier as described earlier. The product can be placed between the two laser boundary markings. The conveyor belts 102a, 102b can move the product under the safety enclosure 118 via the first opening 138s and through the cutting mechanism 114 which cuts the product into two halves that can be approximately equal in size. The conveyor belts 102a, 102b can continue to move the two pieces of the cut product through the second opening 138b of the safety enclosure 118 to a second end of the moving platform where the user can retrieve the two pieces of the cut product. After the product is placed on the moving platform, is cut, and exits the safety enclosure 118, the method 200 proceeds to block 208.

In block 208, each piece of the cut product can be packaged. For example, the user (or a different user who placed the product on the moving platform) can package the half sheets of bacon. The packaged bacon can be provided to restaurants or others for sale or use. After one or more products are packaged, the method 200 can proceed to block 210.

In block 210, the conveyor belts 102a, 102b can be stopped. For example, a user can press the stop controller or button 126 which can stop the motor 106 which in turn causes the conveyor belts 102a, 102b to stop. After stopping the conveyor belts 102a, 102b and motor 106, the method 200 can proceed to block 212.

In block 212, the slicing apparatus 100 can be turned off. For example, a user can press the power controller or button 122 which stops the supply of power to the motor 106 and to the lasers 136. In case of an emergency, a user can also press the emergency controller or switch 124 which can cause the motor to shut down which can cause the conveyor belts 102a, 102b to stop. In addition, the lasers 136 can turn off when the emergency controller or switch 124 is pressed.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. An apparatus comprising:
a cutting mechanism configured to cut a product;
a moving platform comprising two side by side conveyor belts, the moving platform configured to receive the product on the conveyor belts at a first end of the moving platform, to move the product at about the cutting mechanism thereby cutting the product into two cut products, and to provide the two cut products to a second end of the moving platform; and
a motor coupled to the moving platform and configured to move the moving platform.

2. The apparatus of claim 1 wherein the cutting mechanism is a cutting wheel.

3. The apparatus of claim 1 wherein the cutting mechanism is a counterbalanced top cutter wheel.

4. The apparatus of claim 1 wherein the cutting mechanism is a saw blade.

5. The apparatus of claim 1 further comprising a safety enclosure substantially surrounding the cutting mechanism and forming a first opening and a second opening between a top surface of the moving platform and a lower end of each side, the first opening and the second opening being on opposite sides of the safety enclosure and allowing the product to pass through the safety enclosure via the moving platform.

6. The apparatus of claim 1 wherein the moving platform further comprises a plurality of rollers coupled to the conveyor belts and configured to move the conveyor belts.

7. The apparatus of claim 6 wherein one of the rollers is a driven roller coupled to the motor and is driven by the motor.

8. The apparatus of claim 7 wherein the driven roller further comprises at least one pulley and the motor further comprises at least one pulley and at least one pulley belt coupling at least two pulleys whereby the motor drives the conveyor belts via the pulleys and at least one pulley belt.

9. The apparatus of claim 1 further comprising at least one laser emitting visible light onto each of the conveyor belts whereby the emitted visible light provides a visual indication of boundaries for the product.

10. The apparatus of claim 1 further comprising at least one line on each of the conveyor belts whereby the lines provide a visual indication of boundaries for the product.

11. The apparatus of claim 1 wherein the motor is direct current motor.

12. The apparatus of claim 1 wherein the motor is a variable speed direct current motor.

13. The apparatus of claim 12 further comprising a potentiometer configured to control the speed of the motor.

14. The apparatus of claim 1 wherein the product is one of a strip of bacon and a sheet of bacon.

15. The apparatus of claim 14 wherein the bacon is cooked.

16. A method comprising the steps of:
receiving a product on a moving platform coupled to a motor for causing the moving platform to move, wherein the moving platform moves the product into contact with a cutting mechanism, thereby cutting the product into two pieces, and moving the two pieces away from the cutting mechanism for removal of the two cut pieces from the moving platform.

17. The method of claim 16 further comprising packaging each cut piece of product into a package.

18. The method of claim 16 wherein the product is one of a strip of bacon and a sheet of bacon.

19. The method of claim 18 wherein the bacon is cooked.

20. The method of claim 16 further comprising receiving an input to adjust the speed of the motor via a potentiometer.
